(19) United States
(12) Patent Application Publication
(10) Pub. No.: US 2023/0245067 A1
(43) Pub. Date: Aug. 3, 2023

(54) SYSTEM AND METHOD FOR RECOMMENDING POTENTIAL CAREERS OR CAREER PATHS

(71) Applicants: John Baker, Kitchener (CA); Brian Cepuran, Kitchener (CA); Jeremy Auger, Kitchener (CA)

(72) Inventors: John Baker, Kitchener (CA); Brian Cepuran, Kitchener (CA); Jeremy Auger, Kitchener (CA)

(21) Appl. No.: 18/103,863

(22) Filed: Jan. 31, 2023

Related U.S. Application Data
(60) Provisional application No. 63/304,948, filed on Jan. 31, 2022.

(51) Int. Cl. G06Q 10/1053

(52) U.S. Cl. CPC G06Q 10/1053

(57) ABSTRACT

An electronic learning system and method for recommending potential careers, includes: one or more computing devices that communicate over a network and a server. The server is configured to store information for the system, the information including at least one of organization data, user data and historical information pertaining to individuals that followed pre-determined paths or developed pre-determined competencies; and implement at least an analytics engine. The analytics engine is configurable to: determine a role and/or opportunity for a user based at least on one of organization data, user data and historical information pertaining to individuals that followed pre-determined paths or developed pre-determined competencies; recommend individuals for roles based on characteristics pertaining to the individual and historical information pertaining to others that followed similar paths or developed similar competencies; and provide the recommendation to the at least one computing device.

### CROSS-REFERENCE TO RELATED APPLICATIONS

This application claims the benefit of U.S. Provisional Pat. Application No. 63/304,948 filed on Jan. 31, 2022. The entire contents of U.S. Provisional Pat. Application No. 63/304,948 are hereby incorporated herein by reference for all purposes.

### TECHNICAL FIELD

The embodiments herein relate to the field of electronic learning and, in particular, to systems and methods for recommending potential careers or career paths.

### BACKGROUND

Electronic learning (also called e-Learning or eLearning) generally refers to education or learning where users engage in education related activities using computers and other computer devices. For examples, users may enroll or participate in a course or program of study offered by an educational institution (e.g., high school, a college, university, grade school, etc.) through a web interface that is accessible over the Internet. Similarly, users may receive assignments electronically, participate in group work and projects by collaborating online, and be graded based on assignments and examinations that are submitted using an electronic dropbox.

Electronic learning is not limited to use by educational institutions, however, and may also be used in governments or in corporate environments. For example, employees at a regional branch office of a particular company may use electronic learning to participate in a training course offered by their company’s head office without ever physically leaving the branch office.

Electronic learning can also be an individual activity with no institution driving the learning. For example, individuals may participate in self-directed study (e.g., studying an electronic textbook or watching a recorded or live webcast of a lecture) that is not associated with a particular institution or organization.

Electronic learning often occurs without any face-to-face interaction between the users in the educational community. Accordingly, electronic learning overcomes some of the geographic limitations associated with more traditional learning methods, and may eliminate or greatly reduce travel and relocation requirements imposed on users of educational services.

Electronic learning can be useful for people trying to further their careers. For example, an individual can use electronic learning to acquire technical and soft skill competencies necessary to excel within the evolving job market. An individual can also use electronic learning to acquire skills addressing a gap in the market. Further, certain human resources technologies may offer different kinds of recruiting tests, including personality assessments and knowledge-based tests when hiring for new positions. But such technologies may not be based on the functionality and purposes of a job opening. Also, such technologies may not take into account a candidate’s prior education or competencies and/or historical information pertaining to others that followed similar paths or developed similar competencies.

Further, such technologies may not be able to identify candidates that may be good enough to satisfy the requirements of a job opening and assist the candidates in developing new skills for furthering satisfaction of the job requirements. Furthermore, such technology may not be able to recommend promoting a candidate to a role in connection with a personalized learning pathway to assist the candidate in attaining the competencies of the gap between the job requirements and the candidate’s skills.

Accordingly, the inventors have identified a need for systems, methods, and apparatuses that attempt to address at least some of the above-identified challenges.

### SUMMARY

According to a broad aspect, there is provided a system for recommending potential careers, including: one or more computing devices that communicate over a network with the system, at least one computing device comprising a graphical user interface for providing data to the system and outputting data to a user; and a server. The server is configured to: communicate with the one or more computing devices; store information for the system, the information including at least one of organization data, user data and historical information pertaining to individuals that followed pre-determined paths or developed pre-determined competencies; and implement at least an analytics engine. The analytics engine is configurable to: determine a role and/or opportunity for a user based at least on one of organization data, user data and historical information pertaining to individuals that followed pre-determined paths or developed pre-determined competencies; recommend individuals for roles based on characteristics pertaining to the individual and historical information pertaining to others that followed similar paths or developed similar competencies; and provide the recommendation to the at least one computing device.

For example, the analytics engine can include a computer artificial intelligence model that is trained over time with historical data to determine the role and/or opportunity for the user and to recommend individuals for roles.

For example, the computer artificial intelligence model can include at least one of: a probabilistic model, a regression model, or a stochastic model.

For example, the probabilistic model can be adapted to recommend individuals for roles based on characteristics pertaining to the individual, and historical information pertaining to others that followed similar paths or developed similar competencies.

For example, the computer artificial intelligence model can be trained using at least one of: personal profile of an individual, including role, interests, background education, competencies, competency gaps; information from third parties including universities, the information indicating what programs lead into certain skills; crowd sourcing tagging of skills and competencies; Internet sources using semantic analysis; information pertaining to skill gaps at industry level; organizational competencies and needs in relation to competencies of current personnel; and available job opportunities.

For example, the server is further configured to determine an opportunity and/or career role for an individual based on a statistical analysis of an extent of overlap between competencies and/or interests of the individuals.

For example, the server is further configured to match roles and individuals based on a competency gap that is less than a pre-determined threshold.

For example, the server is further configured to recommend a promotion for an individual to a role in connection with a personalized learning pathway to assist the individual in attaining competencies associated with the role.

According to a broad aspect, there is provided a method for recommending potential careers or career paths, including: implementing at least an analytics engine; determining, using the analytics engine, a role and/or opportunity for a user based at least on one of organization data, user data and historical information pertaining to individuals that followed pre-determined paths or developed pre-determined competencies; and recommending, using the analytics engine, individuals for roles based on characteristics pertaining to the individual, and historical information pertaining to others that followed similar paths or developed similar competencies.

For example, the method includes training a computer model over time with historical data to determine the role and/or opportunity for the user and to recommend individuals for roles.

For example, the trained computer model can include at least one of: a probabilistic model, a regression model, or a stochastic model.

For example, the probabilistic model can be adapted to recommend individuals for roles based on characteristics pertaining to the individual, and historical information pertaining to others that followed similar paths or developed similar competencies.

For example, the computer model is trained using at least one of: personal profile of an individual, including role, interests, background education, competencies, competency gaps; information from third parties including universities, the information indicating what programs lead into certain skills; crowd sourcing tagging of skills and competencies; Internet sources using semantic analysis; information pertaining to skill gaps at industry level; organizational competencies and needs in relation to competencies of current personnel; and available job opportunities.

For example, the method can include determining an opportunity and/or career role for an individual based on a statistical analysis of an extent of overlap between competencies and/or interests of the individuals.

For example, the method can include matching roles and individuals based on a competency gap that is less than a pre-determined threshold.

For example, the method can include recommending a promotion for an individual to a role in connection with a personalized learning pathway to assist the individual in attaining competencies associated with the role.

Other aspects and features will become apparent to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1 shows a schematic diagram of components interacting within a system for recommending potential careers or career paths in accordance with some embodiments; and

FIG. 2 shows a flowchart diagram of a method for recommending potential careers or career paths in accordance with some embodiments.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

One or more systems described herein may be implemented in computer programs executing on programmable computers, each comprising at least one processor, a data storage system (including volatile and non-volatile memory and/or storage elements), at least one input device, and at least one output device. For example, and without limitation, the programmable computer may be a programmable logic unit, a mainframe computer, server, and personal computer, cloud based program or system, laptop, personal data assistance, cellular telephone, smartphone, or tablet device.

Each program is preferably implemented in a high level procedural or object oriented programming and/or scripting language to communicate with a computer system. However, the programs can be implemented in assembly or machine language, if desired. In any case, the language may be a compiled or interpreted language. Each such computer program is preferably stored on a storage media or a device readable by a general or special purpose programmable computer for configuring and operating the computer when the storage media or device is read by the computer to perform the procedures described herein.

A description of an embodiment with several components in communication with each other does not imply that all such components are required. On the contrary a variety of optional components are described to illustrate the wide variety of possible embodiments of the present subject matter.

Further, although process steps, method steps, algorithms or the like may be described (in the disclosure and / or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device / article (whether or not they cooperate) may be used in place of a single device / article. Similarly, where more than one device or article is described herein (whether or not they cooperate), it will be readily apparent that a single device / article may be used in place of the more than one device or article.

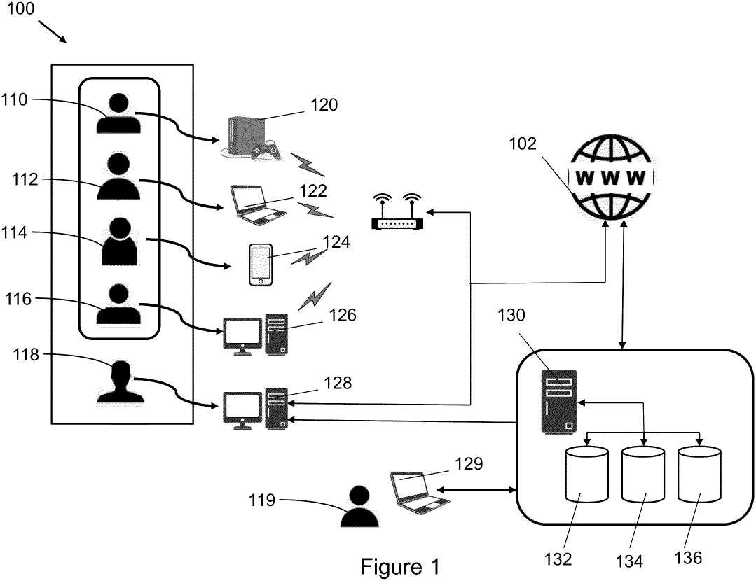

Referring now to FIG. 1, there is shown a schematic diagram of components interacting within a system 100 in accordance with some embodiments. The system can be an electronic learning system. The system 100 may be particularly configured for recommending potential careers or career paths.

The system 100 includes computing devices 120, 122, 124, 126, 128, 129 that communicate over a network 102 with the system 100. The computing devices can include a graphical user interface for providing data to the system and outputting data to users 110, 112, 114, 116, 118, 119 respectively.

The system 100 includes a server 130 configured to communicate with the one or more computing devices 120, 122, 124, 126, 128, 129 over the network 102.

The server 130 can store data on storage devices 132, 134, 136. The data can include at least one of organization data, user data and historical information pertaining to individuals that followed pre-determined paths or developed pre-determined competencies;

The server 130 can implement an analytics engine. The analytics engine represents any engine that can perform operations related to understanding, interpretation of, and actions performed related to a set of received data inputs. For example, the analytics engine can generate one or more predicted likelihoods corresponding to roles and/or opportunities for a user based at least on one of organization data, user data and historical information. For example, the analytics engine can recommend individuals for the roles based on characteristics pertaining to the individual, and historical information pertaining to others that followed similar paths or developed similar competencies.

The analytics engine can, in some instances, also generate UI elements and/or graphics data to provide to a user corresponding to the client device. Examples of the analytics engine that could be used or implemented include a plurality of web services and backend applications, including IBM’s Watson, Google Cloud Natural Language API, Amazon Lez, Microsoft Cognitive Services, as well as any proprietary solution, application, or service. The processing performed by the analytics engine can include processing the received inputs identifying a context.

The analytics engine can determine a role and/or an opportunity for a user based at least on one of organization data, user data and historical information pertaining to individuals that followed pre-determined paths or developed pre-determined competencies.

The analytics engine can recommend individuals for the determined role based on characteristics pertaining to the individual, and historical information pertaining to others that followed similar paths or developed similar competencies.

The analytics engine can provide the recommendation to the at least one computing device. The analytics engine can include a trained computer (AI) model that is trained over time with historical data to determine the role and/or opportunity for the user and to recommend individuals for roles. The trained model can include at least one of: a probabilistic model, a regression model, or a stochastic model. The probabilistic model can recommend individuals for roles based on characteristics pertaining to the individual, and historical information pertaining to others that followed similar paths or developed similar competencies.

Probabilistic models are a form of statistical model, which uses probability distributions to model relationships while accounting for the inherent variability of actual data. The probabilistic model deployed may be part of an artificial intelligence trained model such that, overtime, the strength of positive correlations identified based upon which recommendations may be made improved and thereby the recommendations may become more suitable or appropriate for each user. The artificial intelligence trained model may assign scores or weights to define its confidence, or the probability, that a particular identified correlation is true.

The trained model can be trained using at least one of: personal profile of an individual, including role, interests, background education, competencies, competency gaps; information from third parties including universities, the information indicating what programs lead into certain skills; crowd sourcing tagging of skills and competencies; Internet sources using semantic analysis; information pertaining to skill gaps at industry level; organizational competencies and needs in relation to competencies of current personnel; and available job opportunities.

The server 130, by use of the analytics engine, can also determine an opportunity and/or career role for an individual based on a statistical analysis of an extent of overlap between competencies and/or interests of the individuals.

The server 130, by use of the analytics engine, can match roles and individuals based on a competency gap that is less than a pre-determined threshold.

The server 130, by use of the analytics engine, can recommend a promotion for an individual to a role in connection with a personalized learning pathway to assist the individual in attaining competencies associated with the role.

In some embodiments, the data used by the system 100 can be stored in any one of the data storage devices 132, 134, 136. The data may include at least one of: (I) user personal profile data; (ii) education provider data; (iii) crowd sourcing tagging of skills and/or competencies; (iv) internet sources using semantic analysis; (v) information pertaining to skill gaps at industry level; and (vi) historical data pertaining to other users that followed similar paths or developed similar competencies.

User personal profile data may include personal information input by a user. For example, user personal profile data may include a currently held role, interests, background education, competencies and competency gaps, and other characteristics of the user. Personal profile data may also include personal qualifications (e.g., soft skills such as leadership, presenting, and the like), educational qualifications (e.g., certifications, degrees, and the like), and/or professional qualifications (e.g., past positions held, industry-specific training, and the like), for example. It may also include one or more desired outcomes of a personalized learning pathway, such as the development of one or more target competencies and/or the development of one or more competencies required for a target career.

Education provider data may include information from education providers including colleges and universities, the information indicating what programs lead into certain skills. For example, the colleges and universities may provide data on which course or collection of courses (e.g., program or stream) leads to certain competencies and accreditations. They may also provide data on alumni who have completed the course or collection of courses, such as their characteristics, performance, and the career(s) that they entered following their completion. Education provider data may further include information from other education entities including those that offer training and certification programs, the information indicating what programs lead into certain skills. Similarly, such information may further include data on the career(s) and/or position(s) held by those who have completed the programs.

Crowd sourcing tagging of skills and/or competencies may be sourced, for example, from professional profiles of individuals and/or direct surveying of professionals to identify which skills/competencies/qualifications (collectively referred to as competencies herein) are possessed by individuals in certain careers. Similarly, internet sources (e.g., professional profiles, job postings, and the like) may be parsed using semantic analysis to, for example, identify which competencies are desirable for, and/or commonly associated with, individuals in certain careers. Information pertaining to skill gaps at industry level may also be sourced to identify, for example, which competencies are desirable yet lacking amongst individuals within certain careers.

Historical data pertaining to other users that followed similar paths or developed similar competencies may also be stored, updated, and used to predict future outcomes based on past occurrences. For example, such historical data may reveal that users with a particular combination of personal profile data have an aptitude for one or more specific personal learning pathways and/or a predisposition toward one or more specific careers. Historical data may further include a collection the other types of data associated with the system that has been collected in the past, including the analysis thereof, which may include the particular correlations identified and recommendations made, for example. This may enable the system to provide personalized recommendations to users.

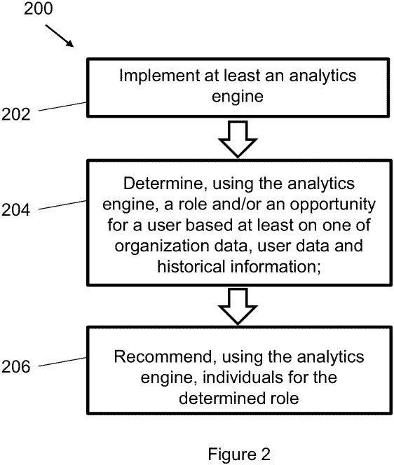

Referring now to FIG. 2, there is shown a method 200 for recommending potential careers or careers paths. At 202, the method includes implementing at least an analytics engine. The analytics engine can analyze information and generate various reports or recommendations which relate to statistical information and trends. The reports contain or are based on correlation data which the analytics engine has identified as being statistically relevant. The method uses the analytics engine to accomplish the various steps described below.

The analytics engine represents any engine that can perform operations related to understanding, interpretation of, and actions performed related to a set of received inputs. For example, the analytics engine can generate one or more predicted likelihoods corresponding to roles and/or opportunities for a user based at least on one of organization data, user data and historical information. For example, the analytics engine can recommend individuals for the roles based on characteristics pertaining to the individual, and historical information pertaining to others that followed similar paths or developed similar competencies. The analytics engine can, in some instances, also generate UI elements and/or graphics data to provide to a user corresponding to the client device. Examples of the analytics engine that could be used or implemented include a plurality of web services and backend applications, including IBM’s Watson, Google Cloud Natural Language API, Amazon Lez, Microsoft Cognitive Services, as well as any proprietary solution, application, or service. The processing performed by the analytics engine can include processing the received inputs identifying a context.

At 204, the method includes determining, using the analytics engine, a role and/or opportunity for a user based at least on one of organization data, user data and historical information pertaining to individuals that followed pre-determined paths or developed pre-determined competencies.

At 206, the method includes recommending, using the analytics engine, individuals for roles based on characteristics pertaining to the individual, and historical information pertaining to others that followed similar paths or developed similar competencies.

The method can include training an artificial intelligence (AI) model over time with historical data to determine the role and/or opportunity for the user and to recommend individuals for roles. The trained AI model can include at least one: of a probabilistic model, a regression model, or a stochastic model.

The probabilistic model can be adapted to recommend individuals for roles based on characteristics pertaining to the individual, and historical information pertaining to others that followed similar paths or developed similar competencies.

For example, the trained AI model can be trained using at least one of: personal profile of an individual, including role, interests, background education, competencies, competency gaps; information from third parties including universities, the information indicating what programs lead into certain skills; crowd sourcing tagging of skills and competencies; Internet sources using semantic analysis; information pertaining to skill gaps at industry level; organizational competencies and needs in relation to competencies of current personnel; and available job opportunities.

The method can also include determining, using the analytics engine, an opportunity and/or career role for an individual based on a statistical analysis of an extent of overlap between competencies and/or interests of the individuals.

The method can include, using the analytics engine, matching roles and individuals based on a competency gap that is less than a pre-determined threshold.

The method can recommend, using the analytics engine, a promotion for an individual to a role in connection with a personalized learning pathway to assist the individual in attaining competencies associated with the role.

In following the method as described herein, the present system and method can advantageously determine a role/opportunity for a user. For example, the system can build a probabilistic model for recommending individuals for roles based on characteristics pertaining to the individual, and historical information pertaining to others that followed similar paths or developed similar competencies.

Inputs of the present system and method can include: (I) personal profile of a user, including role, interests, background education, competencies, competency gaps, etc.; (ii) information from third parties (e.g., universities) indicating what programs lead into certain skills; (iii) crowd sourcing tagging of skills/competencies; (iv) internet sources using semantic analysis; (v) information pertaining to skill gaps at industry level; (vi) organizational competencies, and in particular, needs versus competencies of current personnel; (vii) available job opportunities.

Outputs of the present system and method can include: a recommended opportunity/career role for individuals based on a statistical analysis of the extent of overlap between competencies/interests of individuals and opportunities. For example, the recommendation can include matching roles and individuals based on a competency gap that is less than a (configurable) threshold. For individuals that do not have all competencies (or at least core competencies) to a role, the system and method can deem individuals as good enough. For individuals that are deemed good enough, the system and method can further recommend the promotion to the role in connection with a personalized pathway to assist the individual in attaining the competencies of the gap.

1. A system for recommending potential careers or career paths, comprising:
one or more computing devices that communicate over a network with the system, at least one computing device comprising a graphical user interface for providing data to the system and outputting data to a user; and
a server configured to:
communicate with the one or more computing devices;
store information for the system, the information including at least one of organization data, user data and historical information pertaining to individuals that followed pre-determined paths or developed pre-determined competencies;
implement at least an analytics engine, wherein the at least one analytics engine is configurable to:
determine a role and/or an opportunity for a user based at least on one of organization data, user data and historical information pertaining to individuals that followed pre-determined paths or developed pre-determined competencies;
recommend individuals for the determined role based on characteristics pertaining to the individual, and historical information pertaining to others that followed similar paths or developed similar competencies; and provide the recommendation to the at least one computing device.

2. The system of claim 1, wherein the analytics engine comprises a trained model that is trained over time with historical data to determine the role and/or opportunity for the user and to recommend individuals for roles.

3. The system of claim 2, wherein the trained model comprises at least one of: a probabilistic model, a regression model, and a stochastic model.

4. The system of claim 3, wherein the probabilistic model is adapted to recommend individuals for roles based on characteristics pertaining to the individual, and historical information pertaining to others that followed similar paths or developed similar competencies.

5. The system of claim 1, wherein the trained model is trained using at least one of:
personal profile of an individual, including role, interests, background education, competencies, competency gaps;
information from third parties including universities, the information indicating what programs lead into certain skills;
crowd sourcing tagging of skills and competencies;
Internet sources using semantic analysis;
information pertaining to skill gaps at industry level;
organizational competencies and needs in relation to competencies of current personnel; and
available job opportunities.

6. The system of claim 1, wherein the server is further configured to determine an opportunity and/or career role for an individual based on a statistical analysis of an extent of overlap between competencies and/or interests of the individuals.

7. The system of claim 1, wherein the server is further configured to match roles and individuals based on a competency gap that is less than a pre-determined threshold.

8. The system of claim 1, wherein the server is further configured to recommend a promotion for an individual to a role in connection with a personalized learning pathway to assist the individual in attaining competencies associated with the role.

9. A method for recommending potential careers or careers paths, comprising:
implementing at least an analytics engine;
determining, using the analytics engine, a role and/or opportunity for a user based at least on one of organization data, user data and historical information pertaining to individuals that followed pre-determined paths or developed pre-determined competencies; and
recommending, using the analytics engine, individuals for roles based on characteristics pertaining to the individual, and historical information pertaining to others that followed similar paths or developed similar competencies.

10. The method of claim 9, comprising training a computer model over time with historical data to determine the role and/or opportunity for the user and to recommend individuals for roles.

11. The method of claim 10, wherein the trained computer model comprises at least one of: a probabilistic model, a regression model, or a stochastic model.

12. The method of claim 11, wherein the probabilistic model is adapted to recommend individuals for roles based on characteristics pertaining to the individual, and historical information pertaining to others that followed similar paths or developed similar competencies.

13. The method of claim 10, wherein the trained computer model is trained using at least one of:
personal profile of an individual, including role, interests, background education, competencies, competency gaps;
information from third parties including universities, the information indicating what programs lead into certain skills;
crowd sourcing tagging of skills and competencies;
Internet sources using semantic analysis;
information pertaining to skill gaps at industry level;
organizational competencies and needs in relation to competencies of current personnel; and
available job opportunities.

14. The method of claim 9, comprising determining an opportunity and/or career role for an individual based on a statistical analysis of an extent of overlap between competencies and/or interests of the individuals.

15. The method of claim 9, comprising matching roles and individuals based on a competency gap that is less than a pre-determined threshold.

16. The method of claim 9, comprising recommending a promotion for an individual to a role in connection with a personalized learning pathway to assist the individual in attaining competencies associated with the role.
